(19) United States
(12) Patent Application Publication
(10) Pub. No.: US 2002/0107760 A1
(43) Pub. Date: Aug. 8, 2002

(54) On-line selling system, goods-selling program for use therein and method for supplying item of goods

(75) Inventor: Kaoru Chiba, Tokyo (JP)

Correspondence Address: JORDAN AND HAMBURG LLP, 122 EAST 42ND STREET, SUITE 4000, NEW YORK, NY, 10168, US

(73) Assignee: Konami Corporation, Tokyo (JP)

(21) Appl. No.: 10/072,236

(22) Filed: Feb. 7, 2002

(30) Foreign Application Priority Data
Feb. 8, 2001 (JP) 2001-032784

(51) Int. Cl. G06F 17/60

(52) U.S. Cl. 705/26; 345/839

(57) ABSTRACT

Provided is an on-line selling system that in the process of selecting and buying an item of goods enables a goods supplier to have its own originality concerned therewith that it wants in terms of this process. There are provided two systems. One is a sale processing system that has a function of accepting an order made from a user's terminal by way of a Web site on a server and that can process the delivery of an item of goods the order for that has been accepted to the user as well as the settlement of the goods-item sale price in association with the acceptance of the order made as above. The other is a goods supply system that supplies an item of goods with respect to the sale processing system. The goods supply system provides to the sale processing system a selling program for selling an item of goods that is supplied from the goods supply system. The selling program causes a process of selecting and buying an item of goods being supplied from the goods supply system to be displayed on the monitor of a user's terminal that has made access to the Web site and causes an order for the item of goods bought through the process to occur at the sale processing system.

### BACKGROUND OF THE INVENTION

1. Field of the Invention

The present invention relates to an on-line selling system that, using a sale processing system made up of including the internet or the intranet, enables a supplier for an item of goods to easily sell its own item of goods, and a goods selling program that is used therefor.

2. Description of the Prior Art

Recent utilization on a commercial basis of the Internet is making a remarkable progress, and the on-line selling system based on the utilization of WWW software has been rapidly diffused. The on-line selling system is constructed mainly of a Web site that accepts an order that is made from a user by way of the Internet. When an order to buy occurs with respect to a Web site, an item of goods corresponding to that order is delivered to a designated destination (e.g. a user's home or a retail store in the neighborhood). On the other hand, the selling price for the item of goods is paid by the user transferring the money to a relevant bank account or by the user using his credit card.

As regards the acceptance of an order made utilizing the Web site, making full use of an HTML (Hyper Text Markup Language) or CGI (Common Gateway Interface) the image of the item of goods or letters information is displayed in the window of the WWW browser on the user's terminal. And in case there has been the item of goods the user wants to buy among the goods items that have been made publicly known, the acceptance of that order is performed in the way in which the user selects that item of goods and places that order by designating the amount of it. Incidentally to the acceptance of the order, the user is asked to input the following delivery information and settlement information. Namely, the delivery information necessary for delivery of goods such as the name, address, correspondence destination, etc. and the settlement information necessary for settlement such as the bank account, credit card ID, personal identification number, etc. The information the user has input is distributed to the Web site which the system administrator possesses.

The settlement information that has been sent to the Web site is notified to the credit company, bank, etc. And their authentication is made of the bank account, credit card ID, and personal identification number, confirmation is made of the balance, etc. Thereafter, from the user's account to the seller's designated account the selling price is transferred. On the other hand, the delivery information the Web site has received is notified to a physical distribution trader. The physical distribution system performs operations such as managing the goods in stock, preparing the necessary slips, and delivering the order-accepted item of goods to the user.

In order to administrate an on-line selling system, it is necessary to make full preparations for the equipment of the system enabling the execution of the pieces of processing of order acceptance, delivery, and settlement such as those mentioned above. In order that an entrepreneur who intends to newly establish an on-line selling system may develop a system for executing such pieces of processing, he needs to have necessary know-how or spend a term and share the cost for development. For example, as regards the settlement system for processing the settlement information to make transfer of money concerned, it is necessary to take all possible measures toward the confirmation of the user's ID or the management of the security or the like. Further, it is necessary to make up a system for enabling completing speedy, reliably, and inexpensive settlement processing. In addition, as regards a physical distribution system for distributing goods to the user as well, it is necessary to make full preparations for physical devices such as warehouses, trucks, or deliverymen or for stock management device. And it is also necessary to thereby make up a system for enabling delivering the items of goods to each delivery destination at every quarter all over the country speedily, reliably, and at a low cost. Furthermore, in order to increase the amount of goods sold, it is necessary to increase the number of accesses from general users that become the relevant users. To this end, as regards the order accepting system, it needs to have equipped in itself fascinating contents that are attractive for general users. In addition, it becomes necessary to enhance the degree of publicity to general users through the performance of the relevant propaganda and advertisements.

In this way, when newly opening an on-line selling system, it is necessary to develop the above-described system for order acceptance, delivery, and settlement and to perform maintenance and management of it. Therefore, there is the problem that the cost to be needed for development of the system as well as for maintenance and management of it would suppress the benefit of the on-line selling system. This is followed by a rise in the unit price of goods. In addition, because the development of the system requires the use of a certain period of time, there occurs a case where it is impossible to make a timely start of the sale of the relevant goods. Or there may occur a case where because of having no ideas on the know-how the development of an on-line selling system cannot but be abandoned, too.

On the other hand, if the sale of relevant goods is consigned to the existing on-line selling system, it is possible to perform on-line sale without necessitating the knowledge on the know-how regarding the delivery of the goods and the settlement of the goods prices. However, in that case, it becomes necessary to provide the images, goods information, etc. made to conform to the process of selecting and buying goods that the on-line selling system has already determined. The process of buying goods that the on-line selling system possesses variously differs for each system. So, in order to utilize a lot of on-line selling systems, it is necessary to prepare data individually in specific correspondence with each of those systems. This requires a large amount of time and labor. Further, in case having consigned the sale to an existing on-line selling system, the process of selecting and buying items of goods has difficulty in having originality in itself. Resultantly, that fails effectively to make more vigorous the user's desire for buying items of goods.

Incidentally, attempts have been made to construct a system in which to build a game center on the network. This system is that an item of goods the user has gotten by playing the game there is sent to a user's home or the like. However, in such a system, there is the need for a user to access a prescribed site on the network. It is necessary that the manager of that site should make up a system for goods delivery and price settlement. For this reason, as in the above-described case, there is the problem that the burden following the new participation into the existing on-line selling systems is high in magnitude.

### SUMMARY OF THE INVENTION

Thereupon, it is an object of the present invention to provide an on-line selling system, etc. which enables easy participation into the on-line sale of goods and which, even as for the process of user's selecting and buying an item of goods, enables a goods supplier to have its originality that it wants to possess.

To achieve the above object, an on-line selling system according to the present invention comprises: a sale processing system including a Web site that has a function of accepting an order made from a user's terminal and that can process a delivery of an item of goods the order for that has been accepted as well as a settlement of a goods-item sale price in association with the acceptance of the order; and a goods s up ply system that supplies an item of goods with respect to the sale processing system, wherein the goods supply system is provided therein a program-providing device that provides a selling program for selling the item of goods to be supplied from the goods supply system to the sale processing system; and the selling program causes the user's terminal that has made access to the Web site to display on a monitor thereof a process of selecting and buying an item of goods to be supplied from the goods supply system in association with a user's operation with respect to the user's terminal, and causes the user's terminal to transmit an order for the item of goods bought through the process to the sale processing system.

According to this aspect of the present invention, for an administrator of the goods supply system, it is only needed to deliver the item of goods to a goods delivery destination that has been designated from the administrator of the sale processing system. As regards the settlement of the goods price as well, it needs only to be performed between that administrator of the goods supply system and the administrator of the sale processing system. Also, as regards the delivery of goods to a general user or the settlement of the goods price, it is possible to utilize the function which the Web site of the sale processing system has already possessed, as it is. Therefore, it is possible easily to take new part in the sale based on the utilization of the on-line shopping. The selection and purchase of an item of goods the user makes proceed with the program that has been provided from the goods supply system. Therefore, they are not constricted or bound by the way or manner for selecting and buying goods of the sale processing system. Therefore, it is possible for a goods supplier to make the originality that the goods supplier wants to have. On the other hand, on the part of the sale processing system, it is only needed to place the program provided from the goods supply system into a condition capable of sending it to the user's terminal having made access to the Web site. Simply by this placing, the sale processing system can add the goods supplied from the goods supply system to the goods it handles. As a result of this, it is possible to increase the number of accesses to the Web site.

In the present invention, regarding the delivery of goods and the settlement of the goods price, it is not necessary that the administrator itself of the Web site should develop and do business. Or it is nor necessary that the administrator itself of the Web site should possess part or the whole of the system for delivery or settlement and do its business. For example, as for the delivery of goods, the administrator of the Web site needs only to co-operate with a delivery trader that provides physical distribution services and thereby needs only to make up a system capable of instructing this delivery trader the delivery of relevant goods the order for that has been made by way of the Web site. Similarly, as for the settlement of the selling price, said administrator of the Web site needs only to co-operate with a bank or credit company that provides the settlement services. And it needs only to have made up therefor a system in which to authenticate the user's (buyer's) account, ID, etc. and in which to enable instructing or requesting that bank or credit company the collection of the prices for sold goods from the user.

The selling program for selling items of goods is for example executable in cooperation with the Web browsing program of the user's terminal and is configured as follows. For example, the program makes the user's terminal to display a description such as the marks, icons, letters, etc. for causing the user to recognize that the user can purchase an item of goods are displayed, and for causing the user to buy the item of goods in accordance with prescribed procedures by performing his relevant operation by his clicking the description by means of a pointing device such as a mouse.

As regards the goods in stock in the sale processing system, the trader that undertakes the Web site or delivery manages those goods in stock. If the goods in stock decrease, an order for the goods is made from the Web site administrator with respect to the goods supply system. Resultantly, the goods can be supplied from the goods supply system to the delivery destination (e.g. the custody storehouse) that the sale processing system has designated. The price of the goods that have been delivered in that way can be collected by the goods supply system administrator from the administrator of the Web site of the sale processing system, or from the trader such as a credit company performing by-deputy execution of the settlement. It is also possible to execute the placement of an order for such goods and the settlement of the price therefor through the intermediary of the Internet. The placement of an order in this case is limited to the placement of an order from the administrator of prescribed sale systems each of that is a big-order client. Compared to a case where the administrator of the goods supply system delivers individually to general users, this administrator is able to easily process the goods delivery business.

The on-line selling system of the present invention includes the following embodiments. The selling program may be written in a WWW scripting language and may be provided from the Web site to the user's terminal to thereby be executed on the user's terminal in association with a Web browsing program. If that system is made up like this, simply through making the following preparation it is possible to increase the number of items of goods that are being handled on the Web site and to enhance the attractiveness of the Web site. Namely, in order to cause a prescribed on-line selling Web page to be displayed on the user's terminal, simply through embedding the selling program provided from the goods supply system, beforehand, into a source code for the Web page that has been prepared using an HTML, etc. In this case, selecting and buying an item of goods in the way based on the utilization of the selling program are concluded on the Web site of the sale processing system. Therefore, compared to a case where links are made with the Web site of the relevant purchase destination from that the item of goods is bought, there is no possibility that the user will go on to another site. Namely, for the administrator of the sale processing system, there is the profit that it can enjoy, of preventing the user from escaping from it. On the other hand, for the user, there is the convenience of enabling omitting the time and labor for following the links one after another. Also, the communication period of time can be shortened, too, and therefore the communication cost can also be saved.

In the selling program, an item of goods for being sold to the user may be determined by executing prescribed pieces of lot drawing. If so done, an accidental nature occurs with the selection of the goods items, with the result that the user can enjoy the on-line sale in the sense of playing a game.

The Web site may have the function of causing the user's terminal that has made access thereto to display on the monitor thereof a Web page containing therein a prescribed piece of image associated with the execution of the selling program. And the selling program may be executed in response to the user's selecting operation with respect to that prescribed piece of image. If so done, it is possible to add the function of selling the goods provided from the goods supply system in such a way as to extend the function of the Web page for the Web site.

The selling program may be constructed as follows by causing the user's terminal that has made access to the Web site to display on the monitor thereof an image of a Web vending machine. Namely, so as to cause the user's terminal to transmit an order for the order-accepted item of goods to be supplied from the goods supply system to the sale processing system through a user's prescribed operation associated with the image of that Web vending machine. If so done, the administrator for the sale processing system can add the selling function of selling the items of goods supplied from the goods supply system in the sense of installing an actual automatic vending machine in front of a retail store that the administrator manages. In addition, as for the user, that administrator can make him feel novelty in the process of selecting and buying an item of goods and can make the Web site attractive for him and hence enhance the customer attraction force.

The program providing device may have the function of transmitting the selling program to each client contained in the sale processing system. If so done, the administrator for the sale processing system can handily get the goods selling program.

The program of the present invention is a goods selling program to be provided to a Web site that accepts an order made from a user's terminal. It is therefore arranged that the image of the Web vending machine be displayed on the monitor of the user's terminal having accessed the Web site. And it is thereby arranged that through the user's prescribed operation associated with that Web vending machine, an order for the item of goods be transmitted from the user's terminal to the Web site.

If utilizing the above-described goods selling program, the user can purchase an item of goods in the sense of operating an automatic vending machine on the Web network. And, by combining the goods selling program and the items of goods that are sold with the use of that program, this combined program structure is provided to an existing on-line selling site. As a result of this, it is possible to make up the on-line selling system of the present invention. It is to be noted that the program of the present invention may be written in a WWW scripting language executable on the user's terminal in association with a Web browsing program. Also, it maybe arranged that the user's terminal should execute a piece of processing in which to carry out a prescribed piece of lot drawing and thereby to determine an item of goods that is to be sold to the user.

According to another aspect of the present invention, there is provided a method for supplying an item of goods from a supplier of an item of goods to a sale processing system. The sale processing system includes a Web site that has a function of accepting an order made from a user's terminal and that can process a delivery of an item of goods the order for that has been accepted as well as a settlement of a goods-item sale price in association with the acceptance of the order made. And the method comprises the steps of: providing the sale processing system with a selling program for selling an item of goods to be supplied from the supplier, said selling program causing a user' terminal that has made access to the Web site to display on a monitor thereof a process of selecting and buying the item of goods to be supplied from the supplier in association with a user's operation with respect to the user's terminal, and causes the user's terminal to transmit an order for the item of goods bought through the process to the sale processing system; and supplying the item of goods to the sale processing system in association with a sale thereof made through processing carried out by the selling program.

### BRIEF DESCRIPTION OF THE DRAWINGS

FIG. 1 is a view illustrating a schematic construction of an on-line selling system according to the present invention;

FIG. 2 is a view illustrating a procedure that is executed when buying an item of goods between a Web site and a user's terminal by the use of a Web vending machine;

FIG. 3 is a view illustrating an example of a Web page to be displayed on the monitor of a user's terminal having accessed a relevant Web site;

FIGS. 4A and 4B are views each illustrating an example of a Web vending machine to be displayed when having clicked a button on the Web page of FIG. 3;

FIG. 5 is a view illustrating a procedure that is taken when on-line providing a Web vending machine operating program from a goods supply system server to a sale processing system; and

FIGS. 6A, 6B, and 6C are views each illustrating an example of the screen that is displayed on a terminal of the sale processing system when the processing of FIG. 5 is executed.

### DESCRIPTION OF THE PREFERRED EMBODIMENTS

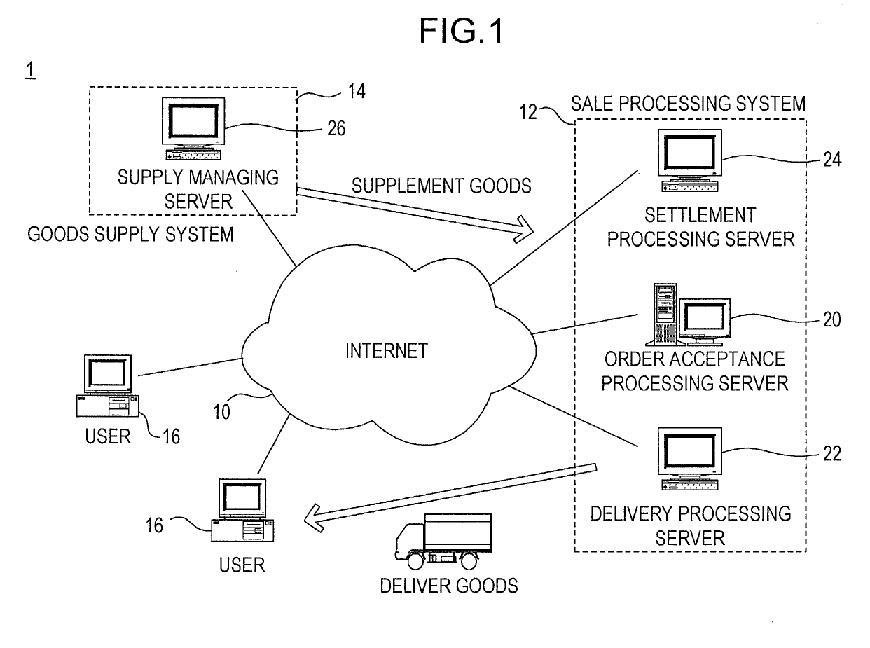

FIG. 1 illustrates a schematic construction of an on-line selling system according to the present invention. The on-line selling system 1 includes the following. One is a sale processing system 12 that is mainly assumed to be an aggregation of traders that are providing their services for on-line shopping on an Internet communication network 10. A second is a goods supply system 14 that is mainly assumed to be traders that supply goods to the sale processing system 12. And a third is a user's terminal 16 that is mainly assumed to be the one in each of user's homes.

The sale processing system 12 includes the following. One is an order acceptance-processing server 20 that accepts an order that is made for an item of goods by way of the Internet 10. And a second and a third are a delivery processing server 22 and a settlement processing server 24 that respectively execute delivery of an item of goods the order for that has been accepted by the order acceptance-processing server 20 and settlement processing for settling the selling price for that item of goods. On the order acceptance processing server 20 there is made up a structure of shopping site. On the user's terminal 16, by designating a URL that has been allotted to the shopping site, the user can access the shopping site via the Internet and make an order for buying his wanted item of goods. The order for the item of goods that the order acceptance processing server 20 has accepted is sent via the Internet 10 to the delivery processing server 22 and the settlement processing server 24. The delivery processing server 22 makes its arranging preparations for the delivery of the item of goods that conforms to the order-accepted contents that the order acceptance-processing server 20 has acknowledge the receipt of. The settlement processing server 24 settles the selling price of the item of goods the order for that has been accepted by the order acceptance-processing server 20. These servers 20, 22, and 24 may be managed by the same entrepreneur or by separate traders. The servers 20, 22, and 24 may be connected to a LAN or a WAN.

Incidentally, the sale processing system 12 is assumed to be the one the structure of that has already been made up on the internet as a shopping mole, an on-line store, a shopping portal, etc. In this embodiment, the following aggregation is handled as the sale processing system irrespective of whatever it may be called or whomever it may be administrated by. The aggregation that is providing their services each having linked together an order for an item of goods that is made by a general user based on the utilization of www, the delivery of that ordered item of goods to a designated place, and the settlement of the selling price. For example, even a Web site that is generally recognized as a search site, if having a shopping function and already having a system in which to deliver an item of goods purchased there and to settle the selling price therefor, is a Web site for executing the sale processing system of the present invention. Also, the sale processing system 12 needs only to contain the order acceptance processing server 20 that has a Web site that is laid open to each of the users' terminals 16. Neither the delivery-processing server 22 nor the settlement-processing server 22 is requisite. The delivery and settlement of the item of goods, the order for that has been made by the order acceptance-processing server 20, need only to be processed in some way or another.

The goods supply system 14 has a supply management server 26 for managing the supply of an item of goods and the like that is directed toward the on-line selling system 12. This goods supply system 14 is one that is being administrated by an entrepreneur which utilizing the sale processing system 12 is planning to sell items of goods. Provided, however, that the goods supply system 14 not only consigns sale of prescribed items of goods to that system 12 but also provides a Web vending machine operating program as a selling program for selling those items of goods thereto. The items of goods that are supplied from the goods supply system 14 are sold through the user's operation of their relevant program on the user's terminal 16. However, the details of that will be described later.

The user's terminal 16 is constructed generally with use of a personal computer. However, if able to access the order acceptance-processing server 20 via the Internet 10, another piece of hardware resource may be utilized. For example, a portable-type computer, a game machine, an Internet television, a portable telephone, etc. maybe utilized as the user's terminal. Provided, however, that the user's terminal 16 needs to have installed therein beforehand the Web browsing program.

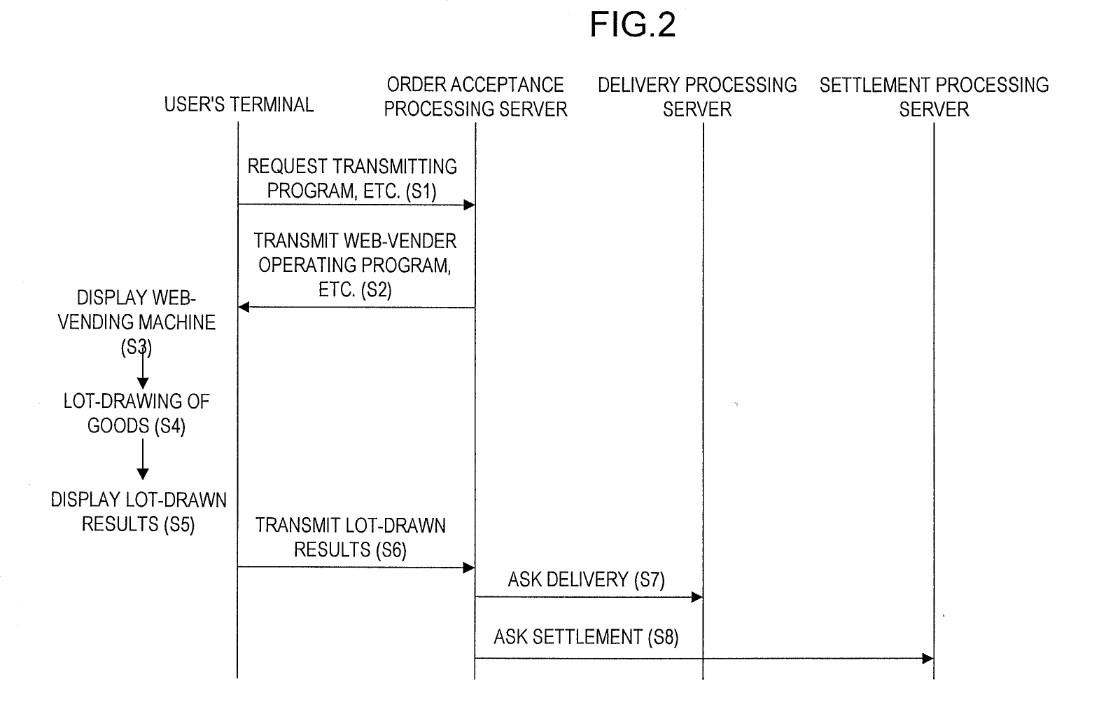

Next, the procedure that is executed when buying an item of goods supplied from the goods supply system 14 through the use of the user's terminal 16 will be explained with reference to FIGS. 2 to 4.

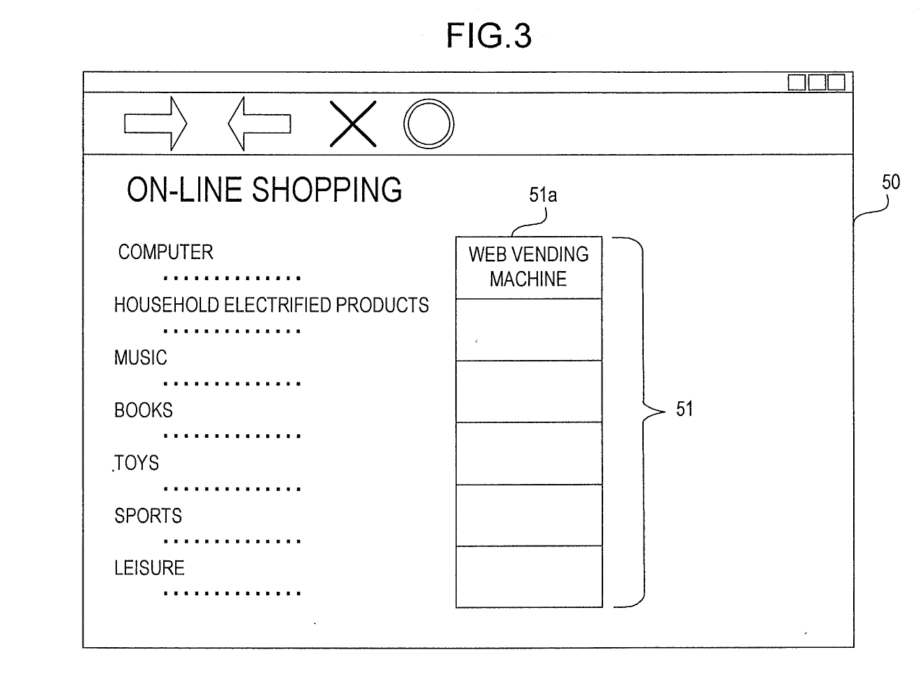

When the user makes a starting of the browser software on his user's terminal 16 to access the shopping site made up on the order acceptance-processing server, on the monitor of the user's terminal 16 there is displayed a Web page 50 for the shopping site such as that illustrated in FIG. 3. On the Web page 50 there are arrayed buttons 51-51 for making a jumping to another Web page or for making a starting of a prescribed script. The program for buying an item of goods supplied from the goods supply system 14 is prepared using the www extended language. Clicking a prescribed one 51a of those buttons 51 by the user permits the program to have its starting made. (The word “click” means selecting the button 51a by means of a pointing device or the like and thereby performing a determination operation that is prepared beforehand.)

FIG. 2 illustrates the procedure after the button 51a has been clicked on a time-sequence basis. When the user clicks the button 51a, a request for transmission of the program, etc. associated with that button 51a is transmitted from the user terminal 16 to the order acceptance-processing server 20 (step S1). The order acceptance-processing server 20 responds to that request. And it transmits to the user's terminal 16 the vendor machine operating program, or data necessary for the operation thereof, that has been provided from the goods supply system 14 (step S2). For example, in case the source code for causing a display of the Web page 50 has embedded therein beforehand the www script that serves as the Web vending machine operating program, image data or the like necessary for operation of the www script is transmitted. Unless the whole or a part of the program is sent to the user's terminal 16 yet, that program, etc. is also transmitted.

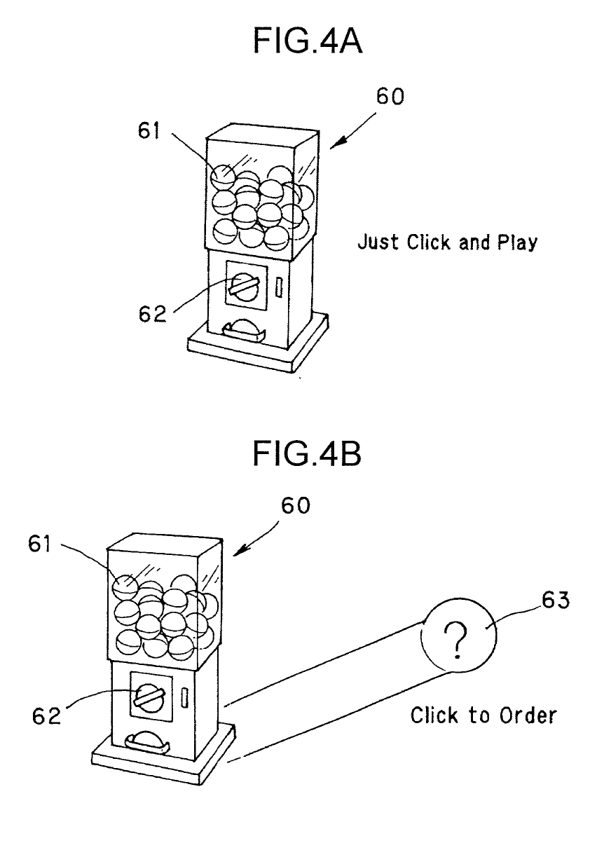

When the Web vending machine operating program and data necessary for the operation thereof are transmitted, that program is executed on the user's terminal 16, whereby the Web vending machine is displayed on the monitor of the user's terminal 16 (step S3). The “Web vending machine” means an imaginary automatic vending machine to be displayed on the window of the Web browser software, or Web browsing program. However, here, especially, it is assumed to be goods selling machine having the nature of a game such as that illustrated in FIG. 4A. Namely, the Web vending machine 60 illustrated in FIG. 4A has a goods storage part 61 for storing therein a plurality of kinds of merchandise and an operation part 62 that is equipped with an operation member such as a handle or a lever. And the Web vending machine 60 is an imaginary goods selling machine that allows the user to operate the operation member in exchange for insertion of a prescribed amount of coin, and randomly selects the goods from among the items of goods according to the operation of the operation member to thereby choose item of goods out for purchase. The Web vending machine 60 may be displayed on the window of the browser program on which the Web page 50 is displayed. Or another window may be opened and that vending machine may be displayed there.

When the Web vending machine 60 is displayed, subsequently lot drawing of an item of goods, that is to be chosen out from the Web vending machine 60 to the user for purchase, is performed on condition that the user has done an operation corresponding to the insertion of a coin (step S4 of FIG. 2). That is, it is thereby determined which one should be chosen out to the user from among a plurality of kinds of the items of goods that have been stored in the storage part 61. Here, as the operation corresponding to the insertion of a coin, for example, as illustrated in FIG. 4B, together with an image of the Web vending machine 60, there is provided a click operation part (the part that is indicated by “?”) 63. It is thereby arranged that, when the user has clicked that part, the program operation be transferred to lot drawing. Of course, the operation that becomes a clue to starting the lot drawing is not limited to the above. So it is considered available that an imaginary coin that has usability on the Web network be displayed on the browser and that a request be made for the user to operate so that the coin may be inserted into the Web vending machine 60 through drag & drop.

Upon completion of the lot drawing of an item of goods, the lot-drawn results are displayed on the monitor of the user's terminal 16 (step S5). Preferably, there is displayed on the user's terminal 16 a moving picture showing that the item of goods is chosen out from the Web vending machine 60 for purchase. Thereafter, the lot-drawn results are transmitted from the user's terminal 16 to the order acceptance-processing server 20 (step S6). As a result of this, in the order acceptance-processing server 20, the item of goods that has been determined as the one that is chosen out to the user is specified. And that item of goods is determined as the one the order for that has been made. Then, the information for making preparations for the delivery of the item of goods is transmitted from the order acceptance-processing server 20 to the delivery-processing server 22 (step S7). On the other hand, the information for making preparations for the settlement of the selling price for that item of goods is transmitted from the server 20 to the settlement-processing server 24 (step S8). As a result of this, the item of goods that the user has gotten by way of the Web vending machine 60 is really delivered to the user self. On the other hand, the buying price for that item of goods, for example, is drawn off from the bank account. It is to be noted that the purchase price for an item of goods is a fixed sum of money regardless of the kind of that item of goods. Namely, a fixed amount of money is charged to the user with respect to the once-performed operation for the Web vending machine 60. On the other hand, a group of items of goods that can be bought through the operation of the Web vending machine 60 can be made to include items of goods therein that are more expensive than the items of goods the price of that is charged through a once-performed operation or items of goods that have a scarcity value.

In this embodiment, in that way, the Web vending machine 60 is displayed on the monitor of the user's terminal 16, and the user imaginarily operates that Web vending machine 60. Through this operation, lot drawing is performed on a user's wanted item of goods he is going to buy. It has thereby been arranged that the user cannot directly select his wanted item of goods. Therefore, it is possible to make the on-line shopping of the present invention have an accidental nature that would not occur with a mere on-line shopping in which the user selects and buys an item of goods he wants to. This makes the user enjoy doing the on-line shopping in the sense of playing a game.

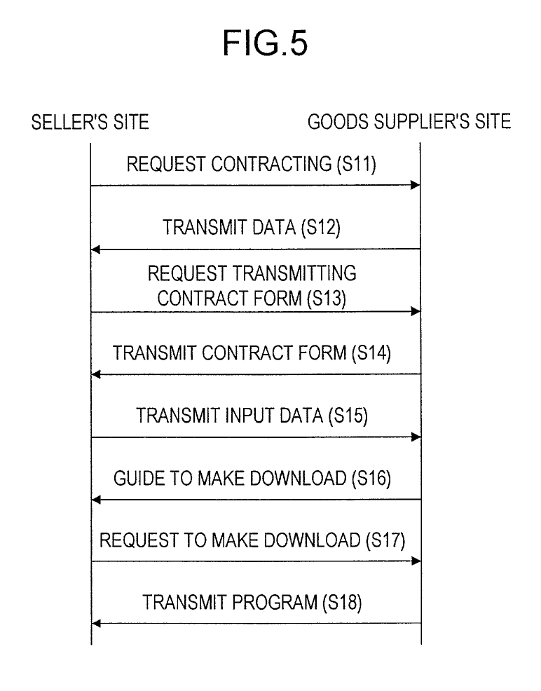

Next, an explanation will be given of an example of the procedure that is performed when providing the Web vending machine operation program from the goods supply system 14 to the sale processing system 12 with reference to FIG. 5. It is to be noted that this example represents a case where the program is provided on line with use of the Internet 10. The explanation will be given under the assumption that the processing on the goods supply system 14 side be executed on the part of a supply-managing server 26. And that the processing on the sale processing system 12 be executed on the part of a not illustrated managing computer connected with the order acceptance-processing server 20 via a LAN, etc. (hereinafter referred to as “a sale managing machine”). However, the processing in each system 12, 14 may be executed using another piece of hardware resources.

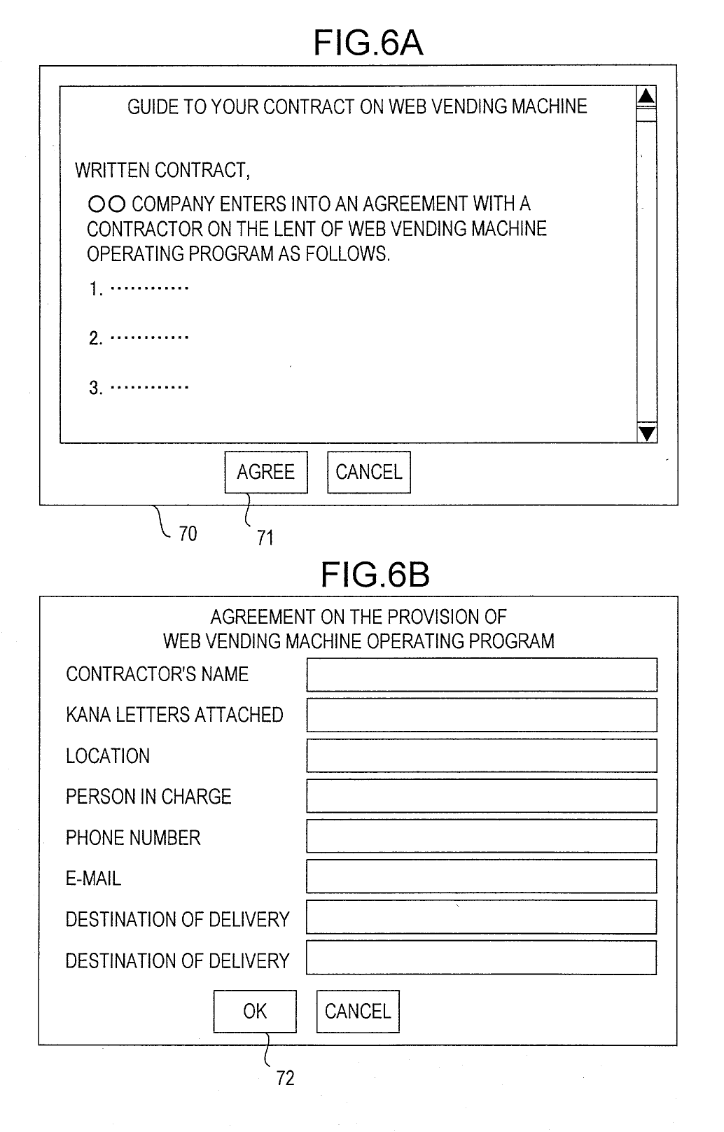

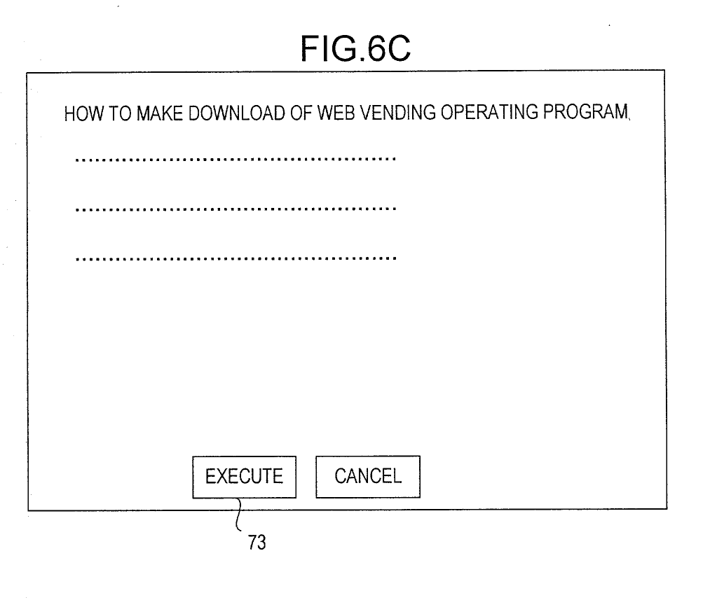

First, an access is had to the supply-managing server 26 from the sale managing machine via the Internet 10 to thereby transmit a request concerning a prescribed goods contract to the server 26 (step S11). Then, the supply managing server 26 transmits to the sale managing machine data that is necessary for displaying a Web page concerning a Web vending machine contract on the browser concerned with the sale managing machine (step S12). This Web page, as illustrated in, for example, FIG. 6A, contains therein the items of contents that are notified to the administrator of the sale processing system 12 in terms of the contents of the contract that is available when providing the program for use for the Web vending machine. When the operator of the sale managing machine clicks a button 71 having written thereon “agree” of the Web page 70 of FIG. 6A, a request to transmit a contract form concerning the provision of the program is made from the sale managing machine to the supply-managing server 26 (step S13). In response thereto, the supply managing server 26 transmits to the sale managing machine data that causes a display of a prescribed contract form on the browser thereof (step S14).

On the monitor of the sale managing machine to which that data has been transmitted, the contract form that contains therein the following contract form is displayed. Namely, as illustrated in, for example, in FIG. 6B, the contract form having contained therein as input items such as the name and address of the contractor (the person whom the program is provided to), the e-mail address, the deliver destination of the item of goods from the goods supply system 14, etc. When the operator for the sale managing machine inputs the requisite items into that contract form and clicks the “OK” button 72, the data that has been input is transmitted to the supply managing server 26 (step S15 of FIG. 15). In response thereto, the supply managing server 26 transmits to the sale managing machine data for displaying a guide screen to the download of the Web vending machine operation program (step S16). The guide screen, as illustrated in, for example, FIG. 6C, is the one wherein the matters that requires attention concerning the download of the program, etc. have been enumerated.

When the operator of the sale managing machine clicks an execution button 73 while understanding the matters that requires attention and that have been described on the guide screen of the download, the following operation occurs. Namely, the request concerning the download of the Web vending machine operation program (including data incidental thereto as well) is transmitted to the supply-managing server 26 (step S17). In response thereto, the supply-managing server 26 transmits the Web vending machine operation program to the sale-managing machine (step S18).

In the sale processing system 12, the program transmitted in that way is placed in a condition of being able to be transmitted to the user's terminal 16 while that program is being associated with the button 51a of the Web page 50 transmitted from the order acceptance-processing server 20 to the user's terminal 16. By doing so, the administrator of the sale-processing system 12 can add the items of goods supplied from the goods supply system 14 to the items of goods that the administrator is handling. This addition can be done without adding new menus, etc.

On the other hand, the administrator of the goods supply system 14 needs only to deliver the item of goods to the delivery destination therefor that has been designated from the administrator side of the sale processing system 12. In addition, as for the settlement of the selling price for the item of goods as well, that administrator needs only to perform the settlement between itself and the administrator of the sale processing system 12 side. For the delivery of the item of goods to a general user or the settlement of the price of it, it is possible to utilize the function the sale processing system 12 already possesses, as it is. Therefore, it is possible to easily take new part in the sale through the intermediary of the on-line shopping. Further, the selection and purchase of an item of goods by the user proceed in accordance with the program that has been provided from the goods supply system 14. They therefore are not bound by the process of selecting and buying the items of goods in the sale processing system 12. Therefore, they can be made to have originality like the nature as a game that is involved in the Web vending machine 60 illustrated in FIG. 4. Therefore, they can encourage the user to have a stronger desire to buy more items of goods.

The present invention is not limited to the above-described embodiment and can be carried out in various kinds of forms. For example, in place of the Web vending machine, a picture image wherein a prescribed character does lot drawing maybe displayed on the user's terminal. By doing so, there may be determined an item of goods that the user buys. In addition, the lot drawing process for causing the process from selecting an item of goods to buying it to be displayed on the user's terminal in accordance with the procedure the goods supplier wants to take is not always necessary. It may be arranged that the user freely chooses his wanted item of goods. Even in this case, it is possible to sell items of goods in a procedure that is different from the selecting/buying process for items of goods the order acceptance-processing server 20 is preparing for. Therefore, it is possible to sell items of goods with use of a method the administrator of the goods supply system 14 wants to use. The provision of the selling program is not limited to the one that is made byway of download. For example, a method may be adopted to receive via the Internet 10 a request for provision of the program that is made from the sale processing system 12. And then to use device of, for example, preparing, on-line, for mailing to the requester of a recording medium such as CD-ROM having the selling program recorded therein.

As has been described above, according to the present invention, the administrator of the goods supply system needs only to deliver the item of goods to the delivery destination therefor that has been designated from the administrator side of the sale processing system. In addition, as for the settlement of the selling price for the item of goods as well, that administrator needs only to perform the settlement between itself and the administrator of the sale processing system side. For the delivery of the item of goods to a general user or the settlement of the price of it, it is possible to utilize the function the sale processing system already possesses, as it is. Therefore, it is possible to easily take new part in the sale through the intermediary of the on-line shopping. Further, the selection and purchase of an item of goods by the user proceed in accordance with the program that has been provided from the goods supply system. They therefore are not bound by the process of selecting and buying the items of goods in the sale processing system. Therefore, they can be made to have originality that the goods supplier wants to possess in the process involved. On the other hand, the sale processing system needs only to place the program provided from the goods supply system into a condition of being able to be transmitted to the user's terminal that has made access to the Web site. As a result of this, the sale processing system can add the items of goods supplied from the goods supply system to the items of goods it is handling. As a result of this, it is possible to increase the number of accesses that are made to the Web site.

What is claimed is:

1. An on-line selling system comprising:
a sale processing system including a Web site that has a function of accepting an order made from a user's terminal and that can process a delivery of an item of goods the order for that has been accepted as well as a settlement of a goods-item sale price in association with the acceptance of the order; and
a goods supply system that supplies an item of goods with respect to the sale processing system, wherein
the goods supply system is provided therein a program-providing device that provides a selling program for selling the item of goods to be supplied from the goods supply system to the sale processing system; and
the selling program causes the user's terminal that has made access to the Web site to display on a monitor thereof a process of selecting and buying an item of goods to be supplied from the goods supply system in association with a user's operation with respect to the user's terminal, and causes the user's terminal to transmit an order for the item of goods bought through the process to the sale processing system.

2. The on-line selling system according to claim 1, wherein the selling program is written in a WWW scripting language and is provided from the Web site to the user's terminal to thereby be executed on the user's terminal in association with a Web browsing program.

3. The on-line selling system according to claim 1, wherein the selling program is configured to execute a prescribed piece of lot-drawing processing to thereby determine an item of goods to be sold to the user.

4. The on-line selling system according to claim 1, wherein
the Web site has a function of causing the user's terminal that has made access thereto to display on the monitor thereof a Web page containing therein a prescribed image associated with execution of the selling program; and
the selling program is executed in response to a user's selecting operation performed with respect to the prescribed image.

5. The on-line selling system according to claim 1, wherein
the selling program causes the user's terminal that has made access to the Web site to display on the monitor thereof an image of a vending machine and causes the user's terminal to transmit the order for the item of goods to be supplied from the goods supply system to the sale processing system through a user's prescribed operation associated with the image of the vending machine.

6. The on-line selling system according to claim 1, wherein
the program-providing device has a function of transmitting the selling program to a client included in the sale processing system.

7. A goods selling program to be provided to a Web site which accepts an order made from a user's terminal, said selling program having a configuration that causes the user's terminal having made access to the Web site to display on a monitor thereof an image of a vending machine and causes the user's terminal to transmit an order made for an item of goods to the Web site through a user's prescribed operation associated with the image of the vending machine.

8. The goods selling program according to claim 7, which is written in a WWW scripting language executable on the user's terminal in association with a Web browsing program.

9. The goods selling program according to claim 7, which is adapted to execute a prescribed piece of lot-drawing processing to make the user's terminal execute processing for determining an item of goods to be sold to the user.

10. A method for supplying an item of goods from a supplier of an item of goods to a sale processing system including a Web site that has a function of accepting an order made from a user's terminal and that can process a delivery of an item of goods the order for that has been accepted as well as a settlement of a goods-item sale price in association with the acceptance of the order made, said method comprising the steps of:
providing the sale processing system with a selling program for selling an item of goods to be supplied from the supplier, said selling program causing a user' terminal that has made access to the Web site to display on a monitor thereof a process of selecting and buying the item of goods to be supplied from the supplier in association with a user's operation with respect to the user's terminal, and causes the user's terminal to transmit an order for the item of goods bought through the process to the sale processing system; and
supplying the item of goods to the sale processing system in association with a sale thereof made through processing carried out by the selling program.

11. The method according to claim 10, wherein the selling program is written in a WWW scripting language and is provided from the Web site to the user's terminal to thereby be executed on the user's terminal in association with a Web browsing program.

12. The method according to claim 10, wherein the selling program is configured to execute a prescribed piece of lot-drawing processing to thereby determine an item of goods to be sold to the user.

13. The method according to claim 10, wherein
the Web site has a function of causing the user's terminal that has made access thereto to display on the monitor thereof a Web page containing therein a prescribed image associated with execution of the selling program; and
the selling program is executed in response to a user's selecting operation performed with respect to the prescribed image.

14. The method according to claim 10, wherein
the selling program causes the user's terminal that has made access to the Web site to display on the monitor thereof an image of a vending machine and causes the user's terminal to transmit the order for the item of goods to the Web site of the sale processing system through a user's prescribed operation associated with the image of the vending machine.

15. The method according to claim 10, wherein the selling program is provided from a server prepared by the supplier to a client included in the sale processing system.
